(19) United States
(12) Patent Application Publication
(10) Pub. No.: US 2009/0254014 A1
(43) Pub. Date: Oct. 8, 2009

(54) MASK FOR MASSAGING THE FACE

(76) Inventor: Gi-Jun SON, INCHEON (KR)

Correspondence Address: IPLA P.A., 3580 WILSHIRE BLVD., 17TH FLOOR, LOS ANGELES, CA, 90010, US

(21) Appl. No.: 12/414,453

(22) Filed: Mar. 30, 2009

(30) Foreign Application Priority Data
Apr. 4, 2008 (KR) 10-2008-0031482

(51) Int. Cl. A61H 7/00

(52) U.S. Cl. 601/134

(57) ABSTRACT

A mask for massaging the face which is able to come close to and massage the face using pneumatic pressure created by the injection of air into the mask. The mask includes a massaging section for massaging the wearer's face using pneumatic pressure, so that the wearer's face is massaged using pneumatic pressure without exerting a negative influence on a human body, nor causing skin trouble and whereby the mask is easy to carry so that the mask is used irrespective of place and time of use.

### CROSS REFERENCE

This application claims foreign priority under Paris Convention and 35 U.S.C. §119 to Korean Patent Application No. 10-2008-0031482, filed Apr. 4, 2008 with the Korean Intellectual Property Office.

### BACKGROUND OF THE INVENTION

1. Field of the Invention

The present invention relates, in general, to a mask for massaging the face and, more particularly, to a mask for massaging the face which is able to come close to and massage the face using pneumatic pressure created by the injection of air into the mask.

2. Description of the Related Art

Recently, as the level of living increases, many people have taken an interest in their health, particularly in a good facial appearance, and the facial region of the human body is a region in which men and women of all ages take a great interest.

Generally, in order to improve the elasticity of the skin of the facial region and prevent the aging of the skin, a diversity of functional cosmetics such as a massage cream or the like are used, and therefore massage services are becoming very popular.

In most massage services, a nutritive wrinkle-free cream for skin management, functional oil or the like is adequately applied onto a facial region, and then a disposal mask is laid over the facial region for a certain time, providing a massage effect to the mask-wearer.

However, such a manner of massaging has problems in that the massaging is inconvenient because it can be carried out only in a restricted place because the mixing and application of massaging materials are done through a very complex process and also in that the incorrect mixing of the massaging materials causes side effects on the facial skin because of the different skin features of each person.

Thus, in order to solve the above problems, a variety of facial massaging masks have recently been developed. A facial mask device for enhancing the looks was disclosed in Korean Patent Registration No. 10-0806291. The facial mask device includes a mask sheet having an air passage therein, a case having, on one end, a connecting hole connected with the air passage, an air supply unit received in the case and supplying air toward the connecting hole, and a heater received between the connecting hole and the air supply unit in the case for generating heat (raising the temperature of air), whereby heated air is continuously supplied to a face inducing sweating and the draining of waste products, making the face fair. However, since the above construction has only the feature of draining sweat from the facial skin, there is no massaging function and it cannot be used by a person who has sensitive or heat-allergic skin.

Further, a facial massaging mask has been disclosed in Korean Utility Model Registration No. 20-0422793. The facial massaging mask includes a mask body having inner and outer surfaces with a space interposed for the flow of water, the inner surface being provided with a plurality of injecting holes and an air tube for breathing, and a fixing belt for fixing the mask body onto a face, whereby the face is massaged by the pressure of the water injected via the injecting holes. However, places where such a construction can be used are limited because of water being used, and it has problems in that a user should inconveniently breathe via the air tube and the water used in massaging is not drained but remains in the mask body.

### SUMMARY OF THE INVENTION

Accordingly, the present invention has been made keeping in mind the above problems occurring in the related art, and the present invention is intended to propose a mask for massaging the face which is able to come close to and massage the face using pneumatic pressure created by the injection of air into the mask.

Further, the present invention intends to propose a mask for massaging the face which is able to massage the face using pneumatic pressure without exerting a negative influence on a human body, and also without causing skin trouble, and which is as such easy to carry so that it can be used irrespective of place and time.

Further, the present invention intends to propose a mask for massaging the face in which finger-pressure protrusions are provided on an inner surface so as to stimulate acupuncture points in the face.

In order to achieve the above objects, according to one aspect of the present invention, there is provided a mask for massaging the face including a massaging section having inner and outer mask bodies, wherein the outer mask body is provided on an outer lower portion with a coupling part, and the inner mask body is coupled with the outer mask body and comes close to a wearer's face; a control box having an air supply unit for injecting and discharging air into and from the massaging section, and a control unit for controlling the air supply unit, thereby creating pneumatic pressure in the massaging section and controlling an amount and a time period of pneumatic pressure creation; and a connecting section coupled to the coupling part of the outer mask body and connecting the massaging section and the control box, whereby the wearer's face is massaged using pneumatic pressure of air injected into the massaging section.

In one embodiment, the inner mask body may be provided on an inner surface with a finger-pressure protrusion capable of stimulating acupuncture points in the wearer's face.

In one embodiment, an inner sheet may be further provided which is placed inside the inner mask body and is provided on an inner surface with finger-pressure protrusions capable of stimulating acupuncture points in the wearer's face.

In one embodiment, the outer mask body may be composed of silicone, and the inner mask body may be composed of a material containing silver nano components and tourmaline components in a base material of silicone.

In one embodiment, the massaging section may be provided on both sides with fastening fittings to which a length-adjustable hair band is coupled.

In one embodiment, the hair band may consist of first and second band portions, which are coupled by means of Velcro-tape.

In one embodiment, the air supply unit may include an air inject pump for injecting air into the massaging section, a first drive motor for actuating the air injecting pump, an air discharge pump for discharging air from the massaging section, and a second drive motor for actuating the air discharge pump.

In one embodiment, the control unit may include a printed circuit board (PCB), a power button mounted on the PCB, a timer mounted on the PCB for controlling an operating time of the air supply unit, a pneumatic-control button mounted on the PCB for controlling the amount of air injected into the massaging section, and an auto-control button mounted on the PCB for automatically controlling the amount of air injected into the massaging section for the time being set by the timer.

In one embodiment, the connecting section may include an air inject hose via which air supplied by the control box is injected into the massaging section, an air discharge hose via which air injected into the massaging section is discharged out, and an additional fixing unit mounted on the coupling part between the massaging section and the connecting section.

According to the above construction of the facial massaging mask of the present invention, the wearer's face can be massaged using pneumatic pressure without exerting a negative influence on a human body, nor providing skin troubles and whereby the mask is easy to carry so that the mask can be used irrespective of places and time.

Further, the finger-pressure protrusions provided on the inner surface of the mask stimulate acupuncture points in the face, promoting blood circulation and preventing skin aging.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a perspective view illustrating a mask for massaging the face according to the present invention;

FIG. 2 is an exploded perspective view illustrating the mask according to the present invention;

FIG. 3 is a plan view illustrating the inside of a massaging section of the mask illustrated in FIG. 2;

FIG. 4 is a plan view illustrating another embodiment of the massaging section of the mask illustrated in FIG. 2; and

FIG. 5 is a construction view illustrating details of a control box of the mask illustrated in FIG. 1.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

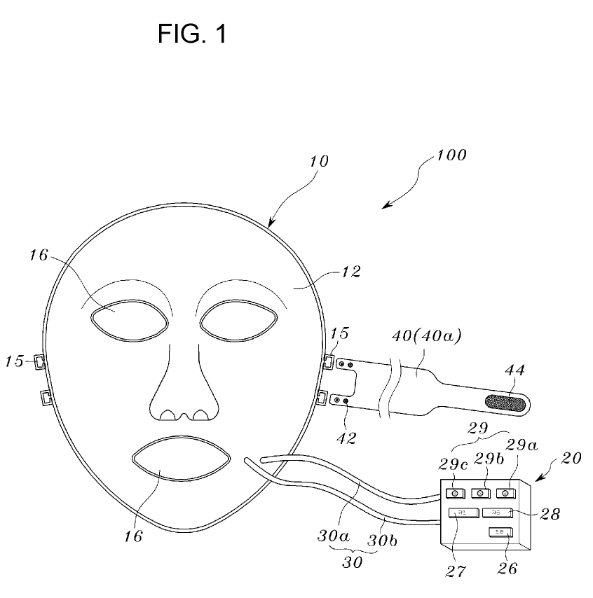

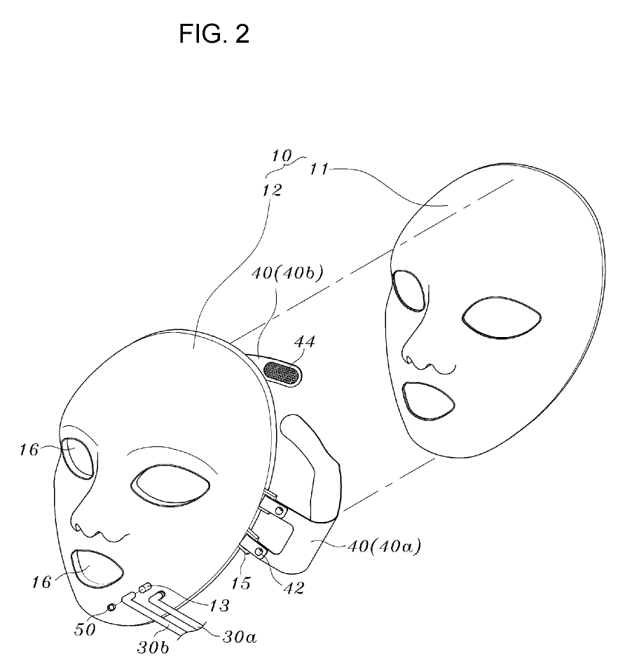

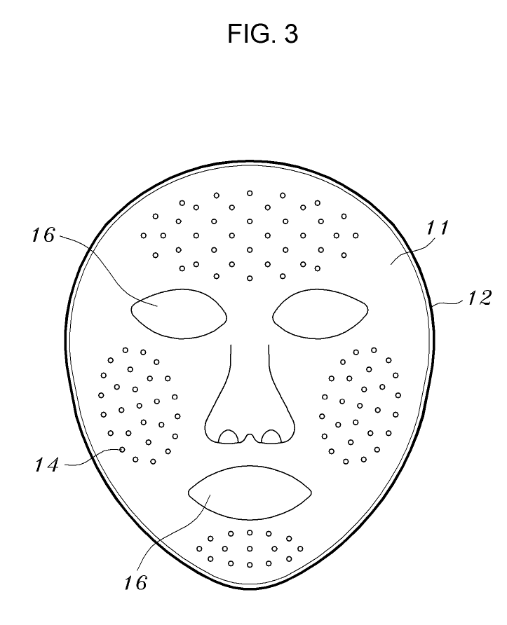

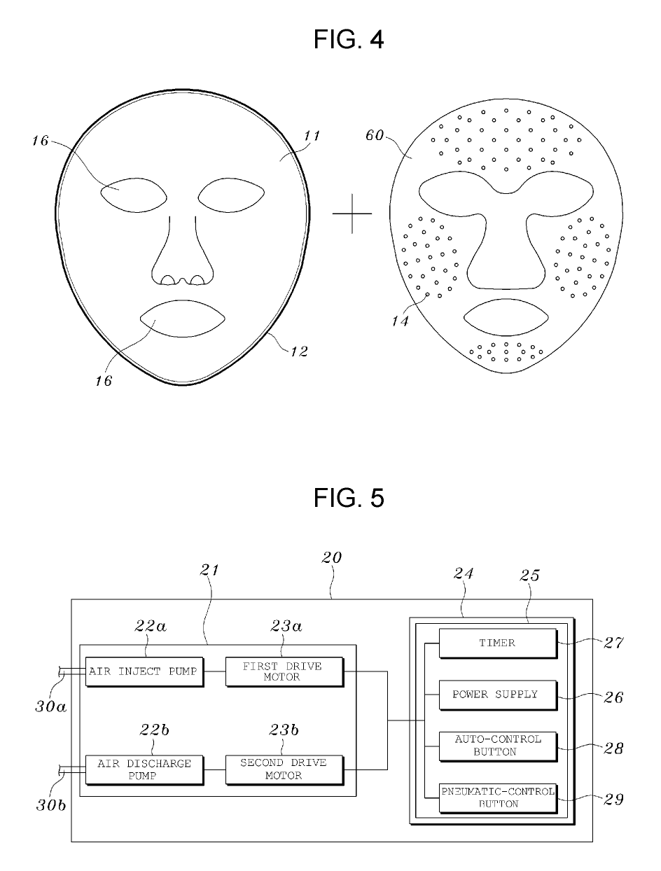

FIG. 1 is a perspective view illustrating a mask for massaging the face according to the present invention, FIG. 2 is an exploded perspective view illustrating the mask according to the present invention, FIG. 3 is a plan view illustrating the inside of a massaging section of the mask illustrated in FIG. 2, FIG. 4 is a plan view illustrating another embodiment of the massaging section of the mask illustrated in FIG. 2, and FIG. 5 is a construction view illustrating details of a control box of the mask illustrated in FIG. 1.

The present invention relates to a mask 100 for massaging the face which is able to come close to and massage the face using pneumatic pressure created by the injection of air into the mask. The mask generally includes a massaging section 10, a control box 20, and a connecting section 30.

The massaging section 10 is a portion which comes close to the wearer's face and massages the face using pneumatic pressure of air supplied by means of the control box 20. The massaging section includes an inner mask body 11 coming into contact with the wearer's face and an outer mask body 12 coupled to the outside of the inner mask body 11.

The inner and outer mask bodies 11 and 12 have openings 16 on specific portions thereof positioned corresponding to the wearer's eyes, nose, and mouth in order to allow the wearer to breathe during massaging and not to feel stuffy.

The inner and outer mask bodies 11 and 12 are coupled together by means of bonding means (not shown) such as an adhesive, which is applied onto corresponding circumferences of the inner and outer mask bodies 11 and 12 and corresponding outer peripheral portions of the openings 16 in order to prevent air injected between the inner and outer mask bodies 11 and 12 from escaping out of the mask bodies.

The inner and outer mask bodies 11 and 12 are composed of resilient silicone so that the mask can be easily worn on the wearer's face irrespective of the size of the face. Here, preferably, the silicone of the inner mask body 11 is more resilient than that of the outer mask body 12, and the thickness of the inner mask body 11 is thinner than that of the outer mask body 112, so that, when air is injected between the inner and outer mask bodies 11 and 12, the outer mask body 12 expands a little, but substantially maintains its original shape, while the inner mask body 11 expands more so as to massage the face.

Further, since the inner mask body 11 is brought into contact with the wearer's face, antibacterial silver nano components, anion-generating components, and tourmaline components are added to silicone of the inner mask body so as to clean the wearer's facial skin and prevent the skin from aging as well.

As illustrated in FIG. 3, finger-pressure protrusions 14 may be provided on the inner surface of the inner mask body 11, which comes close to the wearer's face. The finger-pressure protrusions 14 are positioned corresponding to acupuncture points in a human's face, so that, upon injecting the air for massaging, they both massage the wearer's face while the inner mask body 11 expands and stimulate the acupuncture points in the face, thereby promoting the blood circulation and refreshing the wearer.

In the case where a user should go out of doors after facial massaging or a user should be massaged outdoors, the embarrassing situation may occur that after massaging, imprints are generated on positions of the face where the finger-pressure protrusions 14 are provided. To avoid this situation, an inner sheet 60 having been provided on an inner surface with the finger-pressure protrusions 14 may be separately provided and the finger-pressure protrusions are not formed on the inner mask body, so that a user can selectively use the inner sheet according to his schedule. That is, if a user has enough time to get a massage, as illustrated in FIG. 4, before massaging, when the user places the inner sheet 60, on which the finger-pressure protrusions 14 are formed on positions corresponding to those of acupuncture points in the user's face, on the user's facial region and wears the massaging section, similar to the embodiment shown in FIG. 3, the finger-pressure protrusions 14 stimulate the acupuncture points in the face, promoting the blood circulation and refreshing the user's body. Here, the inner sheet 60 with finger-pressure protrusions 14 may of course be detachably coupled to the inner surface of the inner mask body 11. Thus, when the inner sheet 60 with the finger-pressure protrusions 14 is separately provided, there is an advantage that a user can selectively implement acupuncture-style massaging.

Meanwhile, in order to lay the mask 100 onto the facial region, a fixing unit for fixing the massaging section 10 onto the wearer's face is required. The fixing unit may be a hair band 40. That is, the massaging section 10 is provided on both sides with fastening fittings 15, to which the hair band 40 is coupled, so that the mask 100 can be fixed onto the wearer's face by using the hair band 40 and worn.

Here, the hair band 40 is configured to be composed of strongly resilient material and to be length-adjustable so that the mask can be closely worn on the wearer's face while bring the massaging section 10 into close contact with the face through adjusting the length of the hair band 40 in conformity with the wearer's head. Specifically, the hair band 40 consists of first and second hair band portions 40a and 40b which are respectively coupled with the fastening fittings 15 on both sides of the massaging section 10. The first and second hair band portions are provided on first ends with fitting buttons 42 for easy coupling and decoupling, and on second ends, i.e. those which come into contact with each other, with male and female pieces of Velcro-tape 44, so that the hair band 40 can be easily length-adjustable according to the size of the user's head, and the user can easily put on or remove the mask 100 from the user's face.

The control box 20 serves to both inject air into the massaging section 10 and discharge injected air from the massaging section so as to create pneumatic pressure for massaging the facial muscle, and control an amount and duration of the pneumatic pressure created. The control box 20 is connected with the massaging section 10 by means of a connecting section 30.

The control box 20 generally includes an air supply unit (i.e. pneumatic pressure creating/releasing unit) 21 and a control unit 24. The air supply unit 21 injects and discharges air into and from the massaging section 10, i.e. the portion between the inner and outer mask bodies 11 and 12, so as to create pneumatic pressure. The air supply unit 21 includes an air inject pump 22a for injecting air into the massaging section 10, a first drive motor 23a for actuating the air injecting pump 22a, an air discharge pump 22b for discharging air from the massaging section 10, and a second drive motor 23b for actuating the air discharge pump 22b.

Further, the control unit 24 is provided for controlling the amount and duration of pneumatic pressure created and released by means of the air supply unit 21. The control unit includes a printed circuit board (PCB) 25, a power button 26 mounted on the PCB 25, and a timer 27 mounted on the PCB 25 for controlling operating time of the air supply unit 21.

That is, in the state where a user wears the mask 100 on his face, when the power button 26 on the PCB 25 is pushed down, electric power is supplied to the first drive motor 23a from a power supply (not shown) so as to drive the motor. Then, air is supplied from the air inject pump 22a into the massaging section, i.e. the portion between the inner and outer mask bodies 11 and 12, via the connecting section 30, so that the inner mask body 11 expands to apply force onto the user's face and massage the same. Here, when air is injected in a certain quantity into the massaging section 10 and the force pressing against the user's face reaches a desired level, the first drive motor 23a stops rotating and the second drive motor 23b starts to rotate, so that the air discharge pump 22b sucks air injected into the massaging section 10 and discharges the same out of the massaging section. When a certain amount of air in the massaging section 10 is discharged, the second drive motor 23b stops rotating and the first drive motor 23a starts to rotate again, so as to inject air into the massaging section 10. Such processes repeat and the facial muscle can be massaged using pneumatic pressure.

Meanwhile, the timer 27 mounted on the PCB 25 serves to set the operating time of the air supply unit 21 to allow a user to massage his face for the desired amount of time.

Further, the PCB 25 may be further provided with a pneumatic-control button 28 which is able to regulate the intensity of the massaging. The pneumatic-control button 29 consists of a high-level button 29a, a mid-level button 29b, and a low-level button 29c as shown in FIG. 1, and serves to regulate the amount of air injected into the massaging section 10. That is, the pneumatic-control button 29 regulates the operating time of the first and second drive motors 23a and 23b and thus also regulates the amount of air injected into and discharged from the massaging section 10 via the air inject pump 22a and the air discharge pump 22b, thereby controlling the degree of pneumatic pressure applied onto the user's face and selecting the intensity of massaging to satisfy the user's preference.

In addition, the PCB 25 may be further provided with an auto-control button 28 for automatically controlling the amount of air injected into the massaging section 10 for the time set by the timer 27, which during massaging, makes the intensity of pneumatic pressure applied onto the face subject to automatic control.

The detailed constructions of the above-mentioned timer 27, pneumatic-control button 29, and auto-control button 28 have been widely used in the related art and other fields, so their detailed description will be omitted.

Meanwhile, the massaging section 10 and the control box 20 are connected by means of the connecting section 30, which serves as a passage to inject air supplied by means of the control box 20 into the massaging section 10 and in turn discharge air injected into the massaging section 10 by means of the control box 20.

That is, the connecting section 30 includes an air inject hose 30a via which air supplied by the control box 20 is injected into the massaging section 10, i.e. the portion between the inner and outer mask bodies 11 and 12, and an air discharge hose 30b via which air injected into the massaging section 10 is discharged by means of the control box 20. The air inject hose 30a and the air discharge hose 30b are connected between the air inject pump 22a and the air discharge pump 22b of the control box 20 at first ends and a coupling part 13 provided on the outer lower end of the outer mask body 12 at the second ends. Thus, air supplied by the air inject pump 22a is injected between the inner and outer mask bodies 11 and 12 via the air inject hose 30a so as to expand the inner mask body 11, massaging the user's face.

Here, preferably, a fixing unit 50 is additionally provided on the outside of the coupling part 13 to which the massaging section 10 and the connecting section 30 are coupled, so as to prevent the connecting section 30 from detaching from the massaging section 10 and preventing leakage of air being injected into or discharged from the massaging section 10. Specifically, the coupling part 13 may be of an internally threaded portion (not shown) on an outer surface, and the fixing unit 50 may be of an externally threaded portion (not shown), which is engaged with the internally threaded portion, on an inner surface. Then, when the fixing unit 50 is fitted into the end portion of the connecting section 30, the connecting section 30 is coupled to the coupling part 13, and then the fixing unit 50 is rotated, the connecting section 30 is firmly coupled to the coupling part 13, thereby preventing the connecting section 30 from detaching from the coupling part 13 of the massaging section 10 during massaging.

According to the above construction of the facial massaging mask 100 of the present invention, the wearer's face can be massaged using pneumatic pressure without exerting a negative influence on a human body, and without causing skin trouble and whereby the mask is easy to carry so that the mask can be used irrespective of place and time of use.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A mask for massaging the face comprising:
a massaging section having inner and outer mask bodies, wherein the outer mask body is provided on an outer lower portion with a coupling part, and the inner mask body is coupled with the outer mask body and comes close to a wearer's face;
a control box having an air supply unit for injecting and discharging air into and from the massaging section, and a control unit for controlling the air supply unit, thereby creating pneumatic pressure in the massaging section and controlling an amount and a duration time of the pneumatic pressure created; and
a connecting section coupled to the coupling part of the outer mask body and connecting the massaging section and the control box, whereby the wearer's face is massaged using the pneumatic pressure of air injected into the massaging section.

2. The mask for massaging the face according to claim 1, wherein the inner mask body is provided on an inner surface with finger-pressure protrusions capable of stimulating acupuncture points in the wearer's face.

3. The mask for massaging the face according to claim 1, further comprising an inner sheet which is placed inside the inner mask body and is provided on an inner surface with finger-pressure protrusions capable of stimulating acupuncture points in the wearer's face.

4. The mask for massaging the face according to claim 2, wherein the outer mask body is composed of silicone, and the inner mask body is composed of a material containing silver nano components and tourmaline components in a base material of silicone.

5. The mask for massaging the face according to claim 1, wherein the massaging section is provided on both sides with fastening fittings to which a length-adjustable hair band is coupled.

6. The mask for massaging the face according to claim 5, wherein the hair band consists of first and second band portions, which are coupled by means of Velcro-tape.

7. The mask for massaging the face according to claim 1, wherein the air supply unit includes an air inject pump for injecting air into the massaging section, a first drive motor for actuating the air injecting pump, an air discharge pump for discharging air from the massaging section, and a second drive motor for actuating the air discharge pump.

8. The mask for massaging the face according to claim 1, wherein the control unit includes a printed circuit board (PCB), a power button mounted on the PCB, a timer mounted on the PCB for controlling an operating time of the air supply unit, a pneumatic-control button mounted on the PCB for controlling the amount of air injected into the massaging section, and an auto-control button mounted on the PCB for automatically controlling the amount of air injected into the massaging section for the time being set by the timer.

9. The mask for massaging the face according to claim 1, wherein the connecting section includes an air inject hose via which air supplied by the control box is injected into the massaging section, an air discharge hose via which air injected into the massaging section is discharged out, and an additional fixing unit mounted on the coupling part between the massaging section and the connecting section.
